(19) United States
(12) Patent Application Publication
(10) Pub. No.: US 2025/0211363 A1
(43) Pub. Date: Jun. 26, 2025

(54) CQI TRANSMISSION METHOD AND APPARATUS, TERMINAL, AND NETWORK-SIDE DEVICE

(71) Applicant: VIVO MOBILE COMMUNICATION CO., LTD., Dongguan (CN)

(72) Inventor: Qianyao REN, Dongguan (CN)

(73) Assignee: VIVO MOBILE COMMUNICATION CO., LTD., Dongguan (CN)

(21) Appl. No.: 19/078,230

(22) Filed: Mar. 12, 2025

Related U.S. Application Data
(63) Continuation of application No. PCT/CN2023/118570, filed on Sep. 13, 2023.

(30) Foreign Application Priority Data
Sep. 15, 2022 (CN) 202211125016.6

(51) Int. Cl. H04L 1/00; H04B 17/336; H04L 25/02

(52) U.S. Cl. CPC H04L 1/0026; H04B 17/336; H04L 25/0254

(57) ABSTRACT

This application discloses a channel quality indicator (CQI) transmission method and apparatus, a terminal, and a network-side device. The CQI transmission method includes: determining, by a terminal, a target CQI corresponding to second channel information based on first channel information and a target message; and sending, by the terminal, the target CQI to a first network-side device. The target message is used to assist the terminal in determining the target CQI; and the second channel information is information obtained by the first network-side device after inputting channel characteristic information into a second model, the channel characteristic information being information obtained by the terminal after inputting the first channel information into a first model.

### CROSS-REFERENCE TO RELATED APPLICATIONS

This application is a continuation of International Application No. PCT/CN2023/118570, filed Sep. 13, 2023, which claims priority to Chinese Patent Application No. 202211125016.6, filed Sep. 15, 2022. The entire contents of each of the above-referenced applications are expressly incorporated herein by reference.

### TECHNICAL FIELD

This application pertains to the field of communication technologies, and specifically relates to a CQI transmission method and apparatus, a terminal, and a network-side device.

### BACKGROUND

For multi-antenna systems, a transmit end may optimize signal transmission based on channel state information (CSI) to better match the channel state. For example, the transmit end may select an appropriate modulation and coding scheme (MCS) based on the channel quality indicator (CQI) in CSI to achieve link adaptation. According to a precoding matrix indicator (PMI) in the CSI, eigen beamforming may be implemented to maximize the received signal strength or to suppress interference such as inter-cell interference and multi-user interference. Therefore, since multi-input multi-output (MIMO) technology was proposed, how to acquire CSI has been a research hotspot.

In related art, CSI feedback schemes based on an artificial intelligence (AI) model are as follows: A terminal inputs channel information into an encoding network to obtain an encoded result, and transmits the encoded result to a base station; and after receiving the encoded result the base station inputs the encoded result into a decoding network to obtain recovered channel information.

However, in related art, the terminal usually only has a compression model stored without a decompression model, or the decompression model of the terminal is different from that of the base station. The terminal is unable to know about the channel information recovered by the base station and may only use the channel information before compression and encoding to determine a CQI and transmit the CQI to the base station. This may result in a mismatch between the CQI received by the base station and the recovered channel information.

Therefore, how the terminal transmits the CQI that matches the channel information recovered by the base station is an urgent problem to be solved.

### SUMMARY

Embodiments of this application provide a CQI transmission method and apparatus, a terminal, and a network-side device.

According to a first aspect, a CQI transmission method is provided. The method includes:
determining, by a terminal, a target CQI corresponding to second channel information based on first channel information and a target message; and
sending, by the terminal, the target CQI to a first network-side device; where
the target message is used to assist the terminal in determining the target CQI; and the second channel information is information obtained by the first network-side device after inputting channel characteristic information into a second model, the channel characteristic information being information obtained by the terminal after inputting the first channel information into a first model.

According to a second aspect, a CQI transmission method is provided. The method includes:
receiving, by a first network-side device, a target CQI corresponding to second channel information sent by a terminal; where
the second channel information is information obtained by the first network-side device after inputting channel characteristic information into a second model, the channel characteristic information being information obtained by the terminal after inputting first channel information into a first model.

According to a third aspect, a CQI transmission apparatus is provided. The apparatus includes:
a determining module, configured to determine a target CQI corresponding to second channel information based on first channel information and a target message; and
a first sending module, configured to send the target CQI to a first network-side device; where
the target message is used to assist a terminal in determining the target CQI; and the second channel information is information obtained by the first network-side device after inputting channel characteristic information into a second model, the channel characteristic information being information obtained by the terminal after inputting the first channel information into a first model.

According to a fourth aspect, a CQI transmission apparatus is provided. The apparatus includes:
a first receiving module, configured to receive a target CQI corresponding to second channel information sent by a terminal; where
the second channel information is information obtained by a first network-side device after inputting channel characteristic information into a second model, the channel characteristic information being information obtained by the terminal after inputting first channel information into a first model.

According to a fifth aspect, a terminal is provided, where the terminal includes a processor, a memory, and a program or instruction stored in the memory and capable of running on the processor, and when the program or instruction is executed by the processor, the steps of the method according to the first aspect are implemented.

According to a sixth aspect, a terminal is provided, including a processor and a communication interface, where the processor is configured to determine a target CQI corresponding to second channel information based on first channel information and a target message, and the communication interface is configured to send the target CQI to a first network-side device; where
the target message is used to assist a terminal in determining the target CQI; and the second channel information is information obtained by the first network-side device after inputting channel characteristic information into a second model, the channel characteristic information being information obtained by the terminal after inputting the first channel information into a first model.

According to a seventh aspect, a network-side device is provided. The network-side device includes a processor and a memory. The memory has stored thereon a program or instruction capable of running on the processor. When the program or instruction is executed by the processor, the steps of the method according to the second aspect are implemented.

According to an eighth aspect, a network-side device is provided, including a processor and a communication interface, where the communication interface is configured to receive a target CQI corresponding to second channel information sent by a terminal; where the second channel information is information obtained by a first network-side device after inputting channel characteristic information into a second model, the channel characteristic information being information obtained by the terminal after inputting first channel information into a first model.

According to a ninth aspect, a CQI transmission system is provided, including a terminal and a network-side device. The terminal may be configured to execute the steps of the method according to the first aspect, and the network-side device may be configured to execute the steps of the method according to the second aspect.

According to a tenth aspect, a readable storage medium is provided, where a program or instruction is stored in the readable storage medium, and when the program or the instruction is executed by a processor, the steps of the method according to the first aspect are implemented, or the steps of the method according to the second aspect are implemented.

According to an eleventh aspect, a chip is provided, the chip including a processor and a communication interface, where the communication interface is coupled to the processor, and the processor is configured to run a program or instruction to implement the method according to the first aspect, or implement the method according to the second aspect.

According to a twelfth aspect, a computer program/program product is provided, where the computer program/program product is stored in a storage medium, and the computer program/program product is executed by at least one processor to implement the steps of the method according to the first aspect or the steps of the method according to the second aspect.

In the embodiments of this application, the terminal determines a target CQI corresponding to second channel information based on first channel information and a target message, enabling the terminal to determine the target CQI corresponding to the second channel information without knowing the second channel information recovered by a first network-side device and then send the target CQI to the first network-side device, which ensures that the reported target CQI matches the second channel information and reduces scheduling errors.

### BRIEF DESCRIPTION OF DRAWINGS

FIG. 1 is a schematic diagram of a wireless communication system to which embodiments of this application are applicable;

FIG. 2 is a first schematic flowchart of a CQI transmission method according to an embodiment of this application;

FIG. 3 is a second schematic flowchart of a CQI transmission method according to an embodiment of this application;

FIG. 4 is a first schematic structural diagram of a CQI transmission apparatus according to an embodiment of this application;

FIG. 5 is a second schematic structural diagram of a CQI transmission apparatus according to an embodiment of this application;

FIG. 6 is a schematic structural diagram of a communication device according to an embodiment of this application;

FIG. 7 is a schematic structural diagram of a terminal according to an embodiment of this application; and

FIG. 8 is a schematic structural diagram of a network-side device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It is worth noting that the technology described in the embodiments of this application is not limited to Long Term Evolution (LTE)/LTE-Advanced (LTE-A) systems, but may also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, and NR terms are used in most of the following descriptions, although these technologies may also be applied to other communication systems than an NR system application, for example, the 6th Generation (6G) communication system.

FIG. 1 is a schematic diagram of a wireless communication system to which embodiments of this application are applicable. The wireless communication system shown in FIG. 1 includes a terminal 11 and a network-side device 12. The terminal 11 may be a terminal-side device, such as a mobile phone, a tablet personal computer, a laptop computer or a notebook computer, a Personal Digital Assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart appliance (a household device with a wireless communication function, for example, a refrigerator, a television, a washing machine, or furniture), a game console, a personal computer (PC), a teller machine, or a self-service machine. The wearable device includes a smart watch, a smart band, a smart earphone, smart glasses, smart jewelry (a smart bangle, a smart bracelet, a smart ring, a smart necklace, a smart ankle bangle, a smart anklet, or the like), a smart wristband, smart clothing, or the like. It should be noted that a specific type of the terminal 11 is not limited in the embodiments of this application.

The network-side device 12 may include an access network device or a core network device. The access network device may also be referred to as a radio access network device, a Radio Access Network (RAN), a radio access network function, or a radio access network unit. The access network device may include a base station, a WLAN access point, a Wi-Fi node, or the like. The base station may be referred to as NodeB, evolved NodeB (eNB), access point, Base Transceiver Station (BTS), radio base station, radio transceiver, Basic Service Set (BSS), Extended Service Set (ESS), home NodeB, home evolved NodeB, Transmitting Receiving Point (TRP), or other appropriate terms in the art. As long as the same technical effects are achieved, the base station is not limited to any specific technical term. It should be noted that in the embodiments of this application, only the base station in the NR system is used as an example for description, and the specific type of the base station is not limited. The core network device may include but is not limited to at least one of the following: core network node, core network function, Mobility Management Entity (MME), Access and Mobility Management Function (AMF), Session Management Function (SMF), User Plane Function (UPF), Policy Control Function (PCF), Policy and Charging Rules Function (PCRF), Edge Application Server Discovery Function (EASDF), Unified Data Management (UDM), Unified Data Repository (UDR), Home Subscriber Server (HSS), Centralized network configuration (CNC), Network Repository Function (NRF), Network Exposure Function (NEF), local NEF (L-NEF), Binding Support Function (BSF), Application Function (AF), location management function (LMF), Enhanced Serving Mobile Location Centre (E-SMLC), Network Data Analytics Function (NWDAF), or the like. It should be noted that in the embodiments of this application, only the core network device in the NR system is described as an example, and the specific type of the core network device is not limited.

For a clearer understanding of various embodiments of this application, some relevant background knowledge is first described as follows.

Usually, a base station sends a CSI Reference Signal (CSI-RS) on some time and frequency resources of a slot; a terminal carries out channel estimation based on the CSI-RS, computes channel information on this slot, and feeds back a PMI to the base station through a codebook; and the base station combines the channel information based on codebook information fed back by the terminal and carries out data precoding and multiuser scheduling with this information before a next CSI reporting.

In other words, in traditional codebook-based CSI feedback, the terminal projects a precoding matrix onto a selected orthogonal basis and reports stronger coefficients to the base station. The terminal may compute the precoding matrix recovered by the base station based on the reported content and use the recovered precoding matrix to compute a signal-to-noise ratio and obtain a CQI, thus making the CQI correspond to the reported precoding matrix.

To further reduce CSI feedback overhead, the terminal may change reporting PMI per subband to reporting PMI based on delay. Because the channel in the delay domain is more concentrated, a PMI with fewer delays may approximately represent the PMIs for all subbands. That is, the delay domain information is compressed before being reported.

Similarly, to reduce overhead, the base station can precode the CSI-RS in advance and send the encoded CSI-RS to the terminal. The terminal sees a channel corresponding to the encoded CSI-RS, and the terminal only needs to select several ports with higher strength from the ports indicated by the network side and report coefficients corresponding to these ports.

Furthermore, to better compress the channel information, a neural network or machine learning method may be used.

Artificial intelligence is currently widely applied in various fields. There are various implementations of AI modules, such as neural networks, decision trees, support vector machines, and Bayesian classifiers. This application takes a neural network as an example for illustration, but a specific type of the AI module is not limited.

An AI model-based process of compressing and recovering a CSI is as follows: The terminal estimates a CSI-RS, computes channel information, encodes the computed or originally estimated channel information through an encoding network to obtain an encoded result, and sends the encoded results to the base station; and the base station receives the encoded result, inputs it into a decoding network, and recovers the channel information.

In some embodiments, a neural network (that is, AI model) based CSI compression feedback scheme is as follows: An encoding network is used in a terminal to compress and encode channel information, and the compressed content is sent to a base station; and a decoding network is used in the base station to decode the compressed content to recover the channel information. In this point, the decoding network of the base station and the encoding network of the terminal need to be jointly trained to achieve a reasonable match. An encoding model receives channel information as input and produces encoded information as output; and a decoding model receives encoded information as input and produces channel information as output. The encoding network and decoding network may be obtained by training in the following three manners.

Manner 1: A neural network is a joint neural network composed of an encoder at the terminal and a decoder at the base station and is jointly trained by the network side. After the training is completed, the base station sends the encoder network to the terminal.

Manner 2: The terminal and the base station independently train their respective encoding network and decoding network, followed by a matching process to enable the encoding network at the terminal and the decoding network at the base station to match each other.

Manner 3: The terminal trains an encoding model and a decoding model, and the base station trains a decoding model based on original data and an encoded result from the terminal. In this case, the base station does not need to train an encoding model.

However, in the process of transmitting a CQI in CSI based on an AI model, whether the base station trains the network model and sends the encoding part to the terminal, or the terminal and the base station each train the encoding and decoding parts and then match them, it is possible that the terminal does not know the decoding model of the base station. That is, the terminal is unable to compute the channel information recovered by the base station and may only determine a CQI using the channel information before compression and encoding and transmit the CQI to the base station. This may result in a mismatch between the CQI received by the base station and the recovered channel information, that is, the CQI is significantly higher.

Therefore, how the terminal transmits the CQI that matches the channel information recovered by the base station is an urgent problem to be solved.

The following describes in detail a CQI transmission method provided in embodiments of this application through some embodiments and application scenarios thereof with reference to the accompanying drawings.

In the embodiments of this application, the terminal determines a target CQI corresponding to second channel information based on first channel information and a target message, enabling the terminal to determine the target CQI corresponding to the second channel information without knowing the second channel information recovered by a first network-side device and then send the target CQI to the first network-side device, which ensures that the reported target CQI matches the second channel information and reduces scheduling errors.

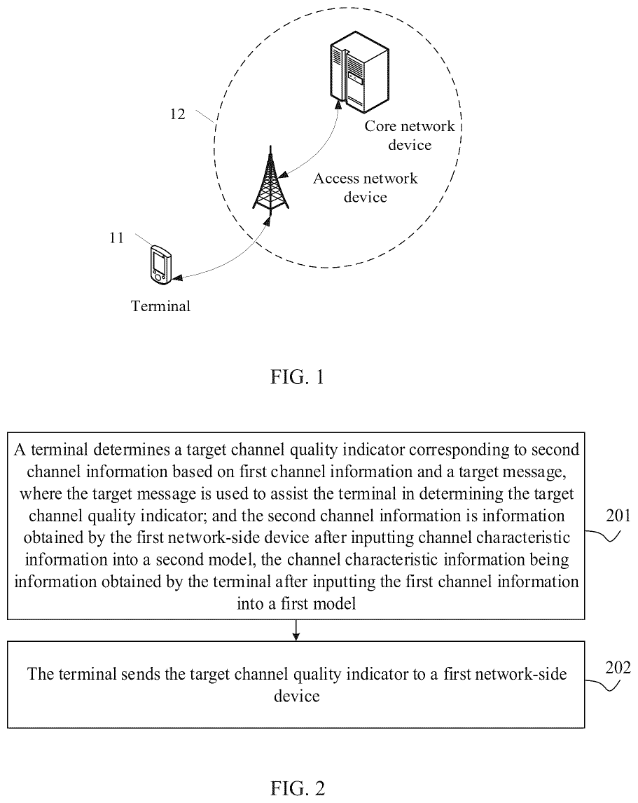

FIG. 2 is a first schematic flowchart of a CQI transmission method according to an embodiment of this application. As shown in FIG. 2, the method includes steps 201 and 202.

Step 201. A terminal determines a target CQI corresponding to second channel information based on first channel information and a target message, where the target message is used to assist the terminal in determining the target CQI; and the second channel information is information obtained by the first network-side device after inputting channel characteristic information into a second model, the channel characteristic information being information obtained by the terminal after inputting the first channel information into a first model.

It should be noted that this embodiment of this application can be applied to CQI transmission scenarios. The terminal includes but is not limited to the types of the terminal 11 listed above, which is not limited in this embodiment of this application; and the first network-side device includes but is not limited to the types of the network-side device 12 listed above, which is not limited in this embodiment of this application.

In the process of transmitting a CQI based on an AI model, the terminal is unable to obtain the channel information (that is, the second channel information) recovered by the first network-side device (for example, base station), therefore, the terminal can use only the channel information (that is, the first channel information) before compression and encoding to determine a CQI and transmit the CQI to the base station. This may result in a mismatch between the CQI received by the base station and the recovered channel information, that is, the CQI is significantly higher. The target message is used to assist the terminal in determining the target CQI without knowing the second channel information.

The second channel information is information obtained by the first network-side device after inputting channel characteristic information into a second model, the channel characteristic information being information obtained by the terminal after inputting first channel information into a first model.

In some embodiments, the first channel information includes: channel information estimated by the terminal; or a precoding matrix obtained by the terminal after computing the estimated channel information.

To transmit the target CQI corresponding to the second channel information to the first network-side device, in this embodiment of this application, the terminal needs to perform channel estimation based on the CSI-RS sent by the first network-side device to obtain the first channel information; and after obtaining the first channel information, the terminal may determine the target CQI corresponding to the second channel information based on the first channel information and the target message from the first network-side device. In other words, the terminal can determine the target CQI corresponding to the second channel information based on the first channel information and the target message even without knowing the second channel information.

In some embodiments, the target message includes at least one of the following:
(a) first information, used to assist the terminal in determining a SINR of the second channel information based on a SINR of the first channel information;
(b) second information, used to assist the terminal in determining a random matrix, the random matrix being used by the terminal to determine the target CQI based on the first channel information;
(c) third information, used to assist the terminal in determining the target CQI based on the CQI corresponding to the first channel information;
(d) a target model;
(e) fourth information, used to instruct the terminal to determine the CQI corresponding to the first channel information as the target CQI; or
(f) fifth information, used to instruct the terminal to determine the target CQI based on a target mapping relationship; the target mapping relationship including a corresponding relationship between SINR and CQI.

Step 202. The terminal sends the target CQI to a first network-side device.

In this embodiment, after determining the target CQI based on the first channel information and the target message, the terminal sends the target CQI to the first network-side device.

In the CQI transmission method provided in this embodiment of this application, the terminal determines a target CQI corresponding to second channel information based on first channel information and a target message, enabling the terminal to determine the target CQI corresponding to the second channel information without knowing the second channel information recovered by a first network-side device and then send the target CQI to the first network-side device, which ensures that the reported target CQI matches the second channel information and reduces scheduling errors.

In some embodiments, the first information includes at least one of the following:
(a) a signal-to-interference-plus-noise ratio SINR backoff value;
(b) a power ratio; or
(c) an amplitude ratio.

In some embodiments, in a case that the first channel information is a multi-rank precoding matrix, the first information corresponds to a layer of the multi-rank precoding matrix, and/or the first information corresponds to a rank of the multi-rank precoding matrix.

In some embodiments, the terminal determining a target CQI corresponding to second channel information based on first channel information and a target message may be implemented in at least one of the following manners.

Manner 1, including the following steps [1] and [2]:
Step [1]. In a case that the target message includes the first information, the terminal determines a SINR of the second channel information based on a SINR of the first channel information and the first information; and
Step [2]. The terminal determines the target CQI based on the SINR of the second channel information.

Manner 2, including the following steps [1] to [3]:
Step [1]. In a case that the target message includes the second information, the terminal determines the random matrix based on the second information;
Step [2]. The terminal determines third channel information based on the random matrix and the first channel information; and
Step [3]. The terminal determines the target CQI based on the SINR of the third channel information.

Manner 3. In a case that the target message includes the third information, the terminal determines the target CQI based on the CQI corresponding to the first channel information and the third information.

Manner 4. In a case that the target message includes the target model, the terminal determines a CQI corresponding to channel information obtained by decoding the channel characteristic information using the target model as the target CQI.

Manner 5. In a case that the target message includes the fourth information, the terminal determines the CQI corresponding to the first channel information as the target CQI.

Manner 6. In a case that the target message includes the fifth information, the terminal determines the target CQI based on the target mapping relationship and the SINR of the first channel information.

Here, the description is provided with respect to manners 1 to 6, respectively.

Manner 1, including the following steps [1] and [2]:
Step [1]. In a case that the target message includes the first information, the terminal determines a SINR of the second channel information based on a SINR of the first channel information and the first information; and
Step [2]. The terminal determines the target CQI based on the SINR of the second channel information.

In this embodiment of this application, in a case that the first information includes the signal-to-interference-plus-noise ratio SINR backoff value, the terminal needs to determine a SINR of the equivalent second channel information based on the SINR of the first channel information and the SINR backoff value; then determine the target CQI based on the SINR of the second channel information.

In some embodiments, after computing the SINR of the first channel information, the terminal needs to subtract the SINR backoff value to obtain the SINR of the second channel information. Based on the SINR of the second channel information, the terminal can quantitatively obtain the target CQI by looking up a CQI table, where the CQI table has a mapping relationship between the SINR of the second channel information and the target CQI.

For example, if the SINR of the first channel information computed by the terminal is 10 dB, and the SINR backoff value indicated by the base station is 2 dB, the terminal determines that the SINR of the second channel information is 8 dB, and an actually reported target CQI is a CQI corresponding to the 8 dB SINR.

In a case that the first information includes a power ratio or an amplitude ratio, the terminal needs to determine a SINR of the second channel information based on the SINR of the first channel information and the power ratio or amplitude ratio; then determine the target CQI based on the SINR of the second channel information.

In some embodiments, after computing the SINR of the first channel information, the terminal needs to multiply it by the power ratio or amplitude ratio to obtain a SINR of the second channel information; and based on the SINR of the second channel information, the terminal can quantitatively obtain the target CQI by looking up a CQI table.

For example, if the SINR of the first channel information computed by the terminal is 20 dB, corresponding to a linear value of 100, and the power ratio indicated by the base station is 0.8, the terminal determines that the SINR of the second channel information is 80, that is, 19 dB; or, if the amplitude ratio indicated by the base station is 0.9, the terminal determines that the SINR of the second channel information is 81, also approximately 19 dB; then an actually reported target CQI is a CQI corresponding to the 19 dB SINR.

It should be noted that in a case that the first channel information is a multi-rank precoding matrix, the power factor or amplitude factor of each layer of the precoding matrix may be different and determined based on the recovery effect of each layer by the AI model, and may be indicated by the base station by layer; and the adjustment for different ranks may be different, for example, using 0.9 for rank 1 and 0.8 for rank 2.

In the foregoing implementation, in a case that the target message includes the first information, the terminal can determine the target CQI corresponding to the second channel information based on the SINR of the first channel information and the first information even without knowing the second channel information.

Manner 2, including the following steps [1] to [3]:
Step [1]. In a case that the target message includes the second information, the terminal determines the random matrix based on the second information;
Step [2]. The terminal determines third channel information based on the random matrix and the first channel information; and
Step [3]. The terminal determines the target CQI based on the SINR of the third channel information.

In some embodiments, the second information includes at least one of the following:
(a) a power ratio;
(b) an amplitude ratio;
(c) a random perturbation value; or
(d) a similarity between the first channel information and the second channel information.

For example, the similarity may be cosine similarity, normalized mean squared error (NMSE), any other metric that describes the relationship between two matrices, or a level that represents the degree of similarity. The description method of similarity is not specifically limited in this application.

In this embodiment of this application, in a case that the second information includes a power ratio or an amplitude ratio, the terminal needs to determine a random matrix based on the power ratio or amplitude ratio; then determine third channel information based on the random matrix and the SINR of the first channel information, and finally based on the SINR of the third channel information, obtain the target CQI corresponding to the SINR by looking up a table according to a corresponding modulation scheme, code rate, and spectral efficiency.

In some embodiments, the terminal needs to generate a random matrix based on the power ratio or amplitude ratio, based on the SINR of the first channel information and the random matrix, obtain the third channel information equivalent to the second channel information, and determine the target CQI based on the SINR of the third channel information.

In a case that the second information includes a random perturbation value or a similarity between the first channel information and the second channel information, the terminal needs to determine a random matrix based on the random perturbation value or the similarity between the first channel information and the second channel information, then determine third channel information based on the random matrix and the first channel information, and finally determine the target CQI based on a SINR of the third channel information.

In some embodiments, the terminal needs to generate a random matrix acting on the first channel information based on the random perturbation value or the similarity between the first channel information and the second channel information, obtain third channel information equivalent to the second channel information (for example, equivalent channel matrix or precoding matrix), then use this equivalent third channel information to compute a corresponding SINR and quantify it as the target CQI.

For example, if the first channel information is a precoding matrix, and the base station indicates that the similarity between the first channel information and the second channel information is 0.9, the terminal randomly generates a complex Gaussian random matrix with zero mean and a variance (that is, random perturbation value) of 0.1, with dimensions equal to the precoding matrix. This random matrix is added to the original first channel information (that is, the precoding matrix), and a resulting matrix is normalized, yielding an equivalent precoding matrix (that is, third channel information). The terminal computes a corresponding SINR, and finally determines a target CQI based on a SINR of the third channel information.

It should be noted that the formula for random perturbation is not limited in this application and may be agreed upon by protocol or implemented by the terminal. The behavior of the random matrix is not limited in this application either. The terminal determines the third channel information based on the correlation indicated by the base station and the first channel information, and then computes the SINR of the third channel information.

It should be noted that in a case that the second channel information is a multi-rank precoding matrix, the random perturbation value or similarity of each layer of the precoding matrix may be different and determined based on the recovery effect of each layer by the AI model, and may be indicated by the base station by layer; and the adjustment for different ranks may be different, for example, using 0.9 for rank 1 and 0.8 for rank 2.

In the foregoing implementation, in a case that the target message includes the second information, the terminal determines a random matrix based on the second information; determines third channel information based on the random matrix and the first channel information; and finally determines the target CQI based on the SINR of the third channel information, which enables the terminal to determine the target CQI corresponding to the second channel information without knowing the second channel information.

Manner 3. In a case that the target message includes the third information, the terminal determines the target CQI based on the CQI corresponding to the first channel information and the third information.

In this embodiment of this application, the third information is used to assist the terminal in determining the target CQI based on the CQI corresponding to the first channel information.

In some embodiments, the third information includes a CQI backoff value or a CQI compensation value, where the CQI compensation value may be positive or negative.

In some embodiments, in a case that the target message indicated by the first network-side device (for example, a base station) includes a CQI compensation value, the terminal needs to compute the SINR of the first channel information, look up the CQI table to obtain the CQI of the first channel information, then add the CQI compensation value to the CQI of the first channel information to determine the target CQI.

In some embodiments, in a case that the target message indicated by the first network-side device (for example, base station) includes a CQI backoff value, the terminal needs to compute the SINR of the first channel information, look up the CQI table to obtain the CQI of the first channel information, then subtract the CQI backoff value from the CQI of the first channel information to determine the target CQI.

For example, if the CQI of the first channel information obtained by the terminal from looking up the CQI table after computing the SINR of the first channel information is 23, and the CQI backoff value indicated by the base station is 3, the target CQI reported by the terminal is 20.

In the foregoing implementation, in a case that the target message includes the third information, the terminal can determine the target CQI corresponding to the second channel information based on the CQI corresponding to the first channel information and the third information without knowing the second channel information.

Manner 4. In a case that the target message includes the target model, the terminal determines a CQI corresponding to channel information obtained by decoding the channel characteristic information using the target model as the target CQI.

In this embodiment of this application, the target model is a public decoding network. The public decoding network may be indicated by the first network-side device, agreed upon by protocol, or trained by the terminal itself.

The terminal uses this public decoding network to decode the channel characteristic information, obtain the decoded channel information, and determine the CQI corresponding to the SINR of the channel information as the target CQI.

Manner 5. In a case that the target message includes the fourth information, the terminal determines the CQI corresponding to the first channel information as the target CQI.

In this embodiment of this application, the fourth information is used to instruct the terminal to determine the CQI corresponding to the first channel information as the target CQI.

For example, the base station sends the fourth information to the terminal, instructing the terminal to compute the CQI using the first channel information before compression and encoding and determine the CQI corresponding to the first channel information as the target CQI, that is, without compensation.

Manner 6. In a case that the target message includes the fifth information, the terminal determines the target CQI based on the target mapping relationship and the SINR of the first channel information.

In this embodiment of this application, the fifth information is used to instruct the terminal to determine the target CQI based on the target mapping relationship; where the target mapping relationship includes the corresponding relationship between SINR and CQI, and the target mapping relationship may be a fixed mapping relationship agreed upon by protocol.

For example, the base station instructs the terminal to use a new CQI table (that is, target mapping relationship) for CQI lookup. The target CQI is then determined by applying compensation based on the table. It should be noted that the target mapping relationship refers to the relationship between CQI and modulation scheme, code rate, and spectral efficiency. The terminal computes corresponding spectral efficiency using a SINR and selects a corresponding CQI under the condition that a block error ratio (BLER) is met.

In some embodiments, the target message corresponds to a user; and/or the target message corresponds to the second model.

In this embodiment, the target message indicated by the first network-side device (for example, base station) for each user may be independent, meaning that the target message corresponds to the user.

If the base station uses a common decoder as the second model, the same target message may be indicated for each user, meaning that the target message corresponds to the second model.

In some embodiments, the terminal obtains the target message in a manner including at least one of the following.

Manner 1. The terminal receives the target message sent by the first network-side device or a second network-side device.

For example, the first network-side device may communicate a corresponding relationship between the target message (for example, CQI backoff value) and an ID of the second model through a broadcast channel, and the terminal determines the CQI backoff value based on the corresponding second model.

In some embodiments, the second network-side network includes at least one of the following:
(a) a base station;
(b) a core network node; or
(c) an artificial intelligence AI model training node.

In some embodiments, the second network-side device may directly send the target message to the terminal; or the second network-side device may send the target message to the terminal through the first network-side device.

Manner 2. The terminal obtains the target message based on a protocol agreement.

Manner 3. The terminal receives the target message sent by a communication device via sidelink.

In some embodiments, in a case of multiple users, the terminal receiving the target message sent by the first network-side device or a second network-side device may be implemented in the following manner, including step 1 and step 2:
Step 1. The terminal receives a corresponding relationship between the target message sent by the first network-side device or the second network-side device and the second model and an identifier of the second model; and
Step 2. The terminal obtains the target message based on the corresponding relationship between the target message and the second model and the identifier of the second model.

In a case of multiple users, the first network-side device or the second network-side device sends the corresponding relationship between the target message and the second model and the identifier of the second model to each terminal, and each terminal may obtain the target message based on the corresponding relationship between the target message and the second model and the identifier of the second model.

In some embodiments, the target message is carried in at least one of the following:
(a) downlink control information DCI;
(b) medium access control MAC control element CE;
In some embodiments, for periodic or semi-persistent CSI reporting, the target message is configured in the CSI report configuration (CSI-reportConfig), and for all subsequent CSI reporting, as long as it is AI model-based CSI reporting, the target CQI is determined using a manner corresponding to the target message; and
for aperiodic CSI reporting, the target message may be configured in each CSI-reportConfig, or the target message may be directly indicated to the terminal using DCI or MACCE; or
(c) radio resource control RRC.

In some embodiments, in configuring the target message directly via RRC signaling, regardless of periodic, semi-persistent, or non-periodic CSI, the terminal uses the manner corresponding to the target message to determine the target CQI whenever the terminal reports the channel characteristic information (for example, PMI) compressed by the first model.

In some embodiments, after the terminal sends the target CQI to the first network-side device, the first network-side device still needs to update the target message, and thus the terminal also needs to perform at least one of the steps below.

(a) The terminal sends the first channel information and/or a CSI identifier to the first network-side device or the second network-side device based on network indication.

In some embodiments, the terminal sends the first channel information to the first network-side device or the second network-side device based on network indication.

Or, the terminal sends the first channel information and the CSI identifier to the first network-side device or the second network-side device based on network indication.

In some embodiments, the CSI identifier may include a CSI report ID or a CSI reference signal resource ID (CSI-RS resource ID).

It should be noted that the terminal may report the first channel information and/or the CSI identifier as Uplink Control Information (UCI) through Physical uplink shared channel (PUSCH) or Physical Uplink Control Channel (PUCCH), or upload it as data through PUSCH.

(b) The terminal sends the first channel information and/or the channel characteristic information to the first network-side device or the second network-side device based on network indication.

It should be noted that the terminal may report the first channel information and/or the channel characteristic information as UCI through PUSCH or PUCCH, or may upload it as data through PUSCH.

In some embodiments, the first channel information may be also carried when the terminal reports channel state information CSI to the first network-side device based on network indication.

In some embodiments, the first network-side device may be triggered by DCI or MACCE or RRC indicating that the terminal carries the first channel information in one or several CSI reports.

The first network-side device may configure the terminal to carry the first channel information at a fixed period, and this configuration may be in the CSI-reportConfig or independent RRC signaling.

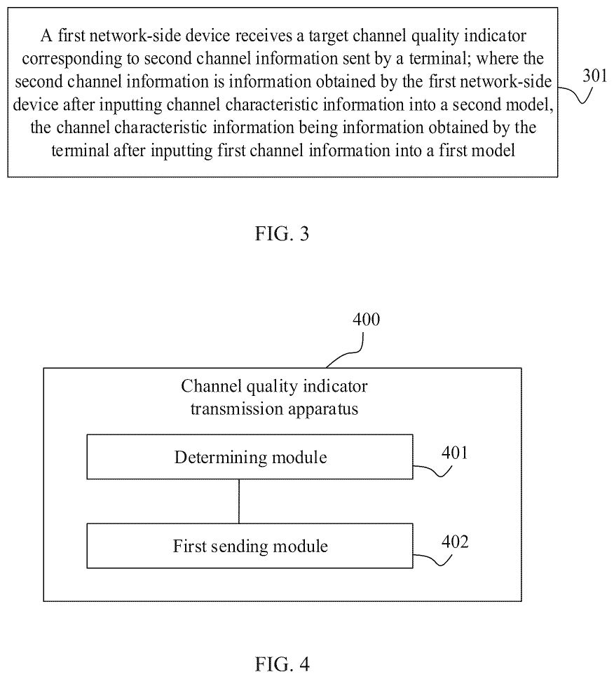

FIG. 3 is a second schematic flowchart of a CQI transmission method according to an embodiment of this application. As shown in FIG. 3, the method includes step 301.

Step 301. A first network-side device receives a target CQI corresponding to second channel information sent by a terminal; where
the second channel information is information obtained by the first network-side device after inputting channel characteristic information into a second model, the channel characteristic information being information obtained by the terminal after inputting first channel information into a first model.

It should be noted that this embodiment of this application can be applied to CQI transmission scenarios. The terminal includes but is not limited to the types of the terminal 11 listed above, which is not limited in this embodiment of this application; and the first network-side device includes but is not limited to the types of the network-side device 12 listed above, which is not limited in this embodiment of this application.

In the process of transmitting a CQI based on an AI model, the terminal is unable to obtain the channel information (that is, the second channel information) recovered by the first network-side device (for example, base station), therefore, the terminal can use only the channel information (that is, the first channel information) before compression and encoding to determine a CQI and transmit the CQI to the base station. This may result in a mismatch between the CQI received by the base station and the recovered channel information, that is, the CQI is significantly higher.

The second channel information is information obtained by the first network-side device after inputting channel characteristic information into a second model, the channel characteristic information being information obtained by the terminal after inputting first channel information into a first model.

In some embodiments, the first channel information includes: channel information estimated by the terminal; or a precoding matrix obtained by the terminal after computing the estimated channel information.

In the CQI transmission method provided in this embodiment of this application, the first network-side device ensures that the target CQI reported by the terminal matches the second channel information by receiving the target CQI corresponding to the second channel information sent by the terminal, thereby reducing scheduling errors.

In some embodiments, before the first network-side device receives the target CQI corresponding to the second channel information sent by the terminal, the first network-side device further needs to send a target message to the terminal, the target message being used to assist the terminal in determining the target CQI.

Accordingly, after receiving the target message from the first network-side device, the terminal may determine the target CQI corresponding to the second channel information based on the first channel information and the target message, and send the target CQI to the first network-side device.

In some embodiments, the target message is carried in at least one of the following:
(a) downlink control information DCI;
(b) medium access control MAC control element CE; or
(c) radio resource control RRC.

In some embodiments, the target message includes at least one of the following:
(a) first information, used to assist the terminal in determining a SINR of the second channel information based on a SINR of the first channel information;
(b) second information, used to assist the terminal in determining a random matrix, the random matrix being used by the terminal to determine the target CQI based on the first channel information;
(c) third information, used to assist the terminal in determining the target CQI based on the CQI corresponding to the first channel information;
(d) a target model;
(e) fourth information, used to instruct the terminal to determine the CQI corresponding to the first channel information as the target CQI; or
(f) fifth information, used to instruct the terminal to determine the target CQI based on a target mapping relationship; the target mapping relationship including a corresponding relationship between SINR and CQI.

In some embodiments, the first information includes at least one of the following:
(a) a signal-to-interference-plus-noise ratio SINR backoff value;
(b) a power ratio; or
(c) an amplitude ratio.

In some embodiments, in a case that the first channel information is a multi-rank precoding matrix, the first information corresponds to a layer of the multi-rank precoding matrix, and/or the first information corresponds to a rank of the multi-rank precoding matrix.

In some embodiments, the second information includes at least one of the following:
(a) a power ratio;
(b) an amplitude ratio;
(c) a random perturbation value; or
(d) a similarity between the first channel information and the second channel information.

In some embodiments, the third information includes a CQI backoff value or a CQI compensation value.

In some embodiments, the target message corresponds to a user; and/or the target message corresponds to the second model.

In some embodiments, in a case of multiple users, the first network-side device sending the target message to the terminal may be implemented in the following manner: The first network-side device sends a corresponding relationship between the target message and the second model and an identifier of the second model to the terminal.

Accordingly, after receiving the corresponding relationship between the target message and the second model and the identifier of the second model sent by the first network-side device, the terminal may obtain the target message based on the corresponding relationship between the target message and the second model and the identifier of the second model.

In some embodiments, after the first network-side device receives the target CQI from the terminal, the first network-side device further needs to update the target message, which may be implemented in any one of the following manners:
Manner 1. The first network-side device receives the first channel information and/or a CSI identifier sent by the terminal; and the first network-side device updates the target message based on the first channel information and/or the CSI identifier; or
Manner 2. The first network-side device receives the first channel information and/or the channel characteristic information sent by the terminal; and the first network-side device updates the target message based on the first channel information and/or the channel characteristic information.

In practical applications, after receiving the first channel information, the first network-side device determines the target message updated based on the first channel information and the channel information recovered from the channel characteristic information, and sends the updated target message to the terminal through any of DCI, MACCE, RRC correction, or reconfiguration.

In some embodiments, the first channel information may be also carried when the terminal reports channel state information CSI to the first network-side device based on network indication.

Accordingly, the first network-side device may also receive the channel state information CSI reported by the terminal; and the CSI carries the first channel information.

The CQI transmission method provided in this embodiment of this application may be executed by a CQI transmission apparatus. In an embodiment of this application, a CQI transmission apparatus provided in the embodiments of this application is described by using an example in which the CQI transmission apparatus executes the CQI transmission method.

FIG. 4 is a first schematic structural diagram of a CQI transmission apparatus according to an embodiment of this application. As shown in FIG. 4, the CQI transmission apparatus 400 includes:
a determining module 401, configured to determine a target CQI corresponding to second channel information based on first channel information and a target message; and
a first sending module 402, configured to send the target CQI to a first network-side device; where
the target message is used to assist a terminal in determining the target CQI; and the second channel information is information obtained by the first network-side device after inputting channel characteristic information into a second model, the channel characteristic information being information obtained by the terminal after inputting the first channel information into a first model.

In the CQI transmission apparatus provided in this embodiment of this application, a target CQI corresponding to second channel information is determined based on first channel information and a target message, enabling the terminal to determine the target CQI corresponding to the second channel information without knowing the second channel information recovered by a first network-side device and then send the target CQI to the first network-side device, which ensures that the reported target CQI matches the second channel information and reduces scheduling errors.

In some embodiments, the target message includes at least one of the following:
first information, used to assist the terminal in determining a SINR of the second channel information based on a SINR of the first channel information;
second information, used to assist the terminal in determining a random matrix, the random matrix being used by the terminal to determine the target CQI based on the first channel information;
third information, used to assist the terminal in determining the target CQI based on the CQI corresponding to the first channel information;
a target model;
fourth information, used to instruct the terminal to determine the CQI corresponding to the first channel information as the target CQI; or fifth information, used to instruct the terminal to determine the target CQI based on a target mapping relationship; the target mapping relationship including a corresponding relationship between SINR and CQI.

In some embodiments, the first information includes at least one of the following:
a signal-to-interference-plus-noise ratio SINR backoff value;
a power ratio; or
an amplitude ratio.

In some embodiments, in a case that the first channel information is a multi-rank precoding matrix, the first information corresponds to a layer of the multi-rank precoding matrix, and/or the first information corresponds to a rank of the multi-rank precoding matrix.

In some embodiments, the determining module 401 is further configured to perform any one of the following:
in a case that the target message includes the first information, determine the SINR of the second channel information based on the SINR of the first channel information and the first information; or
determine the target CQI based on the SINR of the second channel information.

In some embodiments, the second information includes at least one of the following:
a power ratio;
an amplitude ratio;
a random perturbation value; or
a similarity between the first channel information and the second channel information.

In some embodiments, the determining module 401 is further configured to:
in a case that the target message includes the second information, determine, by the terminal, the random matrix based on the second information;
determine, by the terminal, third channel information based on the random matrix and the first channel information; and
determine, by the terminal, the target CQI based on a SINR of the third channel information.

In some embodiments, the determining module 401 is further configured to perform at least one of the following:
in a case that the target message includes the third information, determine the target CQI based on the CQI corresponding to the first channel information and the third information;
in a case that the target message includes the target model, determine a CQI corresponding to channel information obtained by decoding the channel characteristic information using the target model as the target CQI; or
in a case that the target message includes the fifth information, determine the target CQI based on the target mapping relationship and the SINR of the first channel information.

In some embodiments, the third information includes a CQI backoff value or a CQI compensation value.

In some embodiments, the target message corresponds to a user; and/or the target message corresponds to the second model.

In some embodiments, the first channel information includes: channel information estimated by the terminal; or a precoding matrix obtained by the terminal after computing the estimated channel information.

In some embodiments, the apparatus further includes at least one of the following:
a second receiving module, configured to receive the target message sent by the first network-side device or the second network-side device;
an obtaining module, configured to obtain the target message based on a protocol agreement; or
a third receiving module, configured for the terminal to receive the target message sent by a communication device via sidelink.

In some embodiments, the second receiving module is further configured to:
receive the corresponding relationship between the target message and the second model and the identifier of the second model sent by the first network-side device or the second network-side device; and
obtain the target message based on the corresponding relationship between the target message and the second model and the identifier of the second model.

In some embodiments, the second network-side network includes at least one of the following:
a base station; a core network node; or an artificial intelligence AI model training node.

In some embodiments, the target message is carried in at least one of the following:
downlink control information DCI;
medium access control MAC control element CE; or
radio resource control RRC.

In some embodiments, the apparatus further includes at least one of the following:
a second sending module, configured to send the first channel information and/or a CSI identifier to the first network-side device or the second network-side device based on network indication; or
a third sending module, configured to send the first channel information and/or the channel characteristic information to the first network-side device or the second network-side device based on network indication.

In some embodiments, the first channel information is also carried when the terminal reports channel state information CSI to the first network-side device based on network indication.

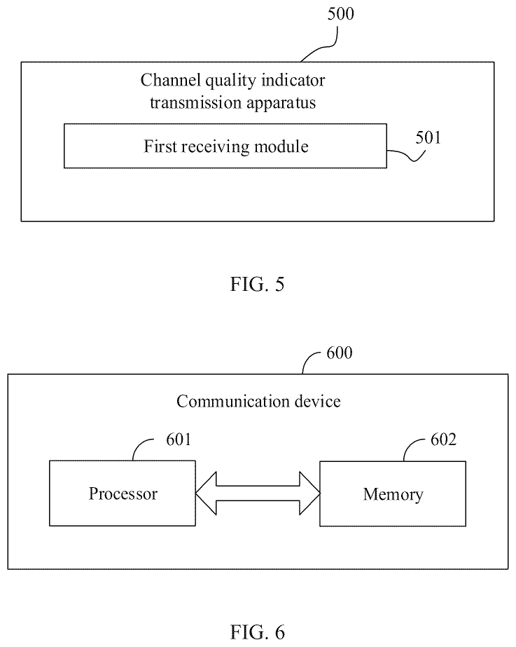

FIG. 5 is a second schematic structural diagram of a CQI transmission apparatus according to an embodiment of this application. As shown in FIG. 5, the CQI transmission apparatus 500 includes:
a first receiving module 501, configured to receive the target CQI corresponding to second channel information sent by a terminal; where
the second channel information is information obtained by a first network-side device after inputting channel characteristic information into a second model, the channel characteristic information being information obtained by the terminal after inputting first channel information into a first model.

In the CQI transmission apparatus provided in this embodiment of this application, it is ensured that the target CQI reported by the terminal matches the second channel information by receiving the target CQI corresponding to the second channel information sent by the terminal, thereby reducing scheduling errors.

In some embodiments, the apparatus further includes:
a fourth sending module, configured to send a target message to the terminal; the target message is used to assist the terminal in determining the target CQI.

In some embodiments, the target message is carried in at least one of the following:
downlink control information DCI;
medium access control MAC control element CE; or
radio resource control RRC.

In some embodiments, the target message includes at least one of the following:
first information, used to assist the terminal in determining a SINR of the second channel information based on a SINR of the first channel information;
second information, used to assist the terminal in determining a random matrix, the random matrix being used by the terminal to determine the target CQI based on the first channel information;
third information, used to assist the terminal in determining the target CQI based on the CQI corresponding to the first channel information;
a target model;
fourth information, used to instruct the terminal to determine the CQI corresponding to the first channel information as the target CQI; or
fifth information, used to instruct the terminal to determine the target CQI based on a target mapping relationship; the target mapping relationship including a corresponding relationship between SINR and CQI.

In some embodiments, the first information includes at least one of the following:
a signal-to-interference-plus-noise ratio SINR backoff value;
a power ratio; or
an amplitude ratio.

In some embodiments, in a case that the first channel information is a multi-rank precoding matrix, the first information corresponds to a layer of the multi-rank precoding matrix, and/or the first information corresponds to a rank of the multi-rank precoding matrix.

In some embodiments, the second information includes at least one of the following:
a power ratio;
an amplitude ratio;
a random perturbation value; or
a similarity between the first channel information and the second channel information.

In some embodiments, the third information includes a CQI backoff value or a CQI compensation value.

In some embodiments, the target message corresponds to a user; and/or the target message corresponds to the second model.

In some embodiments, the first channel information includes: channel information estimated by the terminal; or a precoding matrix obtained by the terminal after computing the estimated channel information.

In some embodiments, the fourth sending module is further configured to:
send a corresponding relationship between the target message and the second model and an identifier of the second model to the terminal.

In some embodiments, the apparatus further includes any one of the following:
a fourth receiving module, configured to receive the first channel information and/or a CSI identifier sent by the terminal;
a first updating module, configured to update the target message based on the first channel information and/or the CSI identifier;
a fifth receiving module, configured to receive the first channel information and/or the channel characteristic information sent by the terminal; or
a second updating module, configured to update the target message based on the first channel information and/or the channel characteristic information.

In some embodiments, the apparatus further includes:
a sixth receiving module, configured to receive the channel state information CSI reported by the terminal; and the CSI carries the first channel information.

The CQI transmission apparatus in this embodiment of this application may be an electronic device such as an electronic device with an operating system, or a component in an electronic device such as an integrated circuit or chip. The electronic device may be a terminal or a device other than terminals. For example, the terminal may include but is not limited to the types of the terminal 11 listed above, and the other device may be a server, a Network Attached Storage (NAS), or the like. This is not specifically limited in this embodiment of this application.

The CQI transmission apparatuses provided in this embodiment of this application can implement the processes that are implemented in the method embodiments of FIG. 2 and FIG. 3, with the same technical effects achieved. To avoid repetition, details are not repeated herein.

FIG. 6 is a schematic structural diagram of a communication device according to an embodiment of this application. As shown in FIG. 6, the communication device 600 includes a processor 601 and a memory 602. The memory 602 has stored thereon a program or instruction capable of running on the processor 601. For example, if the communication device 600 is a terminal, when the program or instruction is executed by the processor 601, the steps of the foregoing embodiments of the CQI transmission method in FIG. 2 are implemented, with the same technical effects achieved. When the communication device 600 is a network-side device, the program or instruction is executed by the processor 601 to implement the steps of the foregoing embodiments of the CQI transmission method in FIG. 3, with the same technical effects achieved. To avoid repetition, details are not repeated herein.

An embodiment of this application further provides a terminal including a processor and a communication interface, the processor being configured to determine a target CQI corresponding to second channel information based on first channel information and a target message, where the target message is used to assist the terminal in determining the target CQI; and the second channel information is information obtained by the first network-side device after inputting channel characteristic information into a second model, the channel characteristic information being information obtained by the terminal after inputting the first channel information into a first model.

The communication interface is configured to send the target CQI to the first network-side device. This terminal embodiment corresponds to the foregoing method embodiment on the terminal side. All processes and implementations in the foregoing method embodiment are applicable to this terminal embodiment, with the same technical effects achieved.

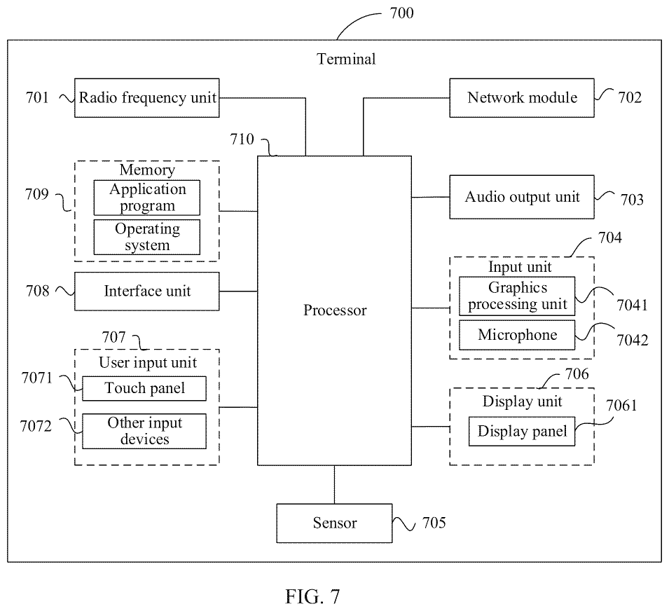

FIG. 7 is a schematic structural diagram of a terminal according to an embodiment of this application. As shown in FIG. 7, the terminal 700 includes but is not limited to at least some of the components such as a radio frequency unit 701, a network module 702, an audio output unit 703, an input unit 704, a sensor 705, a display unit 706, a user input unit 707, an interface unit 708, a memory 709, and a processor 710.

Persons skilled in the art can understand that the terminal 700 may further include a power supply (for example, a battery) supplying power to the components, and the power supply may be logically connected to the processor 710 through a power management system. In this way, functions such as charge management, discharge management, and power consumption management are implemented by using the power management system. The structure of the terminal shown in FIG. 7 does not constitute any limitation on the terminal. The terminal may include more or fewer components than shown in the figure, or a combination of some components, or the components disposed differently. Details are not described herein again.

It can be understood that in this embodiment of this application, the input unit 704 may include a Graphics Processing Unit (GPU) 7041 and a microphone 7042. The graphics processing unit 7041 processes image data of a still picture or video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, and the like. The user input unit 707 includes at least one of a touch panel 7071 or other input devices 7072. The touch panel 7071 is also referred to as a touchscreen. The touch panel 7071 may include two parts: a touch detection apparatus and a touch controller. The other input devices 7072 may include but are not limited to a physical keyboard, a function key (for example, a volume control key or a power on/off key), a trackball, a mouse, and a joystick. Details are not described herein.

In an embodiment of this application, the radio frequency unit 701 receives downlink data from a network-side device and transfers the data to the processor 710 for processing; and the radio frequency unit 701 can additionally send uplink data to the network-side device. Generally, the radio frequency unit 701 includes but is not limited to an antenna, an amplifier, a transceiver, a coupler, a low noise amplifier, and a duplexer.

The memory 709 may be configured to store software programs or instructions and various data. The memory 709 may include a first storage area for storing programs or instructions and a second storage area for storing data. The first storage area may store an operating system, an application program or instructions required by at least one function (for example, a sound playback function or an image playback function), and the like. Additionally, the memory 709 may be a volatile memory or a non-volatile memory, or the memory 709 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 709 in the embodiments of this application includes but is not be limited to these or any other applicable types of memories.

The processor 710 may include one or more processing units. In some embodiments, the processor 710 may integrate an application processor and a modem processor. The application processor primarily processes operations involving an operating system, user interface, application program, or the like. The modem processor primarily processes radio communication signals, for example, being a baseband processor. It can be understood that the modem processor may be not integrated in the processor 710.

An embodiment of this application further provides a network-side device including a processor and a communication interface, the communication interface being configured to receive a target CQI corresponding to second channel information sent by a terminal; where the second channel information is information obtained by the first network-side device after inputting channel characteristic information into a second model, the channel characteristic information being information obtained by the terminal after inputting first channel information into a first model. This network-side device embodiment corresponds to the foregoing network-side device method embodiment. All processes and implementations in the foregoing method embodiment are applicable to this network-side device embodiment, with the same technical effects achieved.

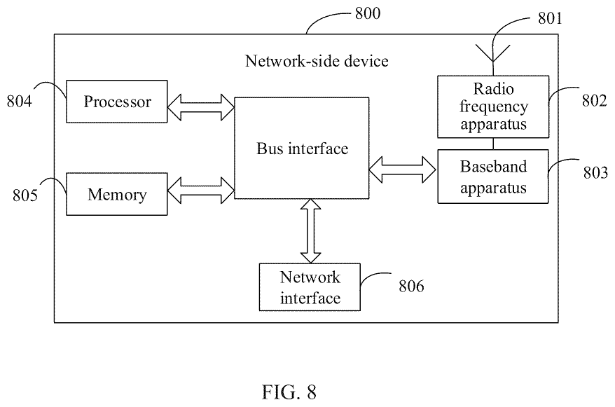

FIG. 8 is a schematic structural diagram of a network-side device according to an embodiment of this application. As shown in FIG. 8, the network-side device 800 includes an antenna 801, a radio frequency apparatus 802, a baseband apparatus 803, a processor 804, and a memory 805. The antenna 801 is connected to the radio frequency apparatus 802. In uplink, the radio frequency apparatus 802 receives information through the antenna 801, and sends the received information to the baseband apparatus 803 for processing. In downlink, the baseband apparatus 803 processes to-be-sent information, and sends the information to the radio frequency apparatus 802; and the radio frequency apparatus 802 processes the received information and then sends the information out through the antenna 801.

The method performed by the network-side device in the foregoing embodiment may be implemented on the baseband apparatus 803. The baseband apparatus 803 includes a baseband processor.

The baseband apparatus 803 may include, for example, at least one baseband processing unit, where a plurality of chips are disposed on the baseband processing unit. As shown in FIG. 8, one of the chips is, for example, a baseband processor, and connected to the memory 805 through a bus interface, to invoke the program in the memory 805 to perform the operations of the network device shown in the foregoing method embodiment.

The network-side device may further include a network interface 806, where the interface is, for example, a common public radio interface (CPRI).

The network-side device 800 in this embodiment of the present application further includes an instruction or program stored in the memory 805 and capable of running on the processor 804. The processor 804 invokes the instruction or program in the memory 805 to execute the foregoing CQI transmission method, with the same technical effects achieved. To avoid repetition, details are not repeated herein.

An embodiment of this application further provides a CQI transmission system including a terminal and a network-side device. The terminal may be configured to execute the steps of the foregoing CQI transmission method, and the network-side device may be configured to execute the steps of the foregoing CQI transmission method.

An embodiment of this application further provides a readable storage medium. The readable storage medium may be volatile or non-volatile. The readable storage medium has stored thereon a program or instruction. When the program or instruction is executed by a processor, the processes of the foregoing embodiments of the CQI transmission methods are implemented, with the same technical effects achieved. To avoid repetition, details are not repeated herein.

The processor is a processor in the terminal described in the foregoing embodiment. The readable storage medium includes a computer-readable storage medium such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instruction to implement the processes of the foregoing embodiments of the CQI transmission methods, with the same technical effects achieved. To avoid repetition, details are not repeated herein.

It should be understood that the chip mentioned in an embodiment of this application may also be referred to as a system-level chip, a system chip, a chip system, a system on a chip, or the like.

An embodiment of this application further provides a computer program/program product, where the computer program/program product is stored in a storage medium, and the computer program/program product is executed by at least one processor to implement the processes of the foregoing embodiments of the CQI transmission methods, with the same technical effects achieved. To avoid repetition, details are not repeated herein.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

According to the description of the foregoing implementations, persons skilled in the art can clearly understand that the methods in the foregoing embodiments may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A channel quality indicator (CQI) transmission method, comprising:
determining, by a terminal, a target CQI corresponding to second channel information based on first channel information and a target message; and
sending, by the terminal, the target CQI to a first network-side device,
wherein the target message is used to assist the terminal in determining the target CQI; and the second channel information is information obtained by the first network-side device after inputting channel characteristic information into a second model, the channel characteristic information being information obtained by the terminal after inputting the first channel information into a first model.

2. The CQI transmission method according to claim 1, wherein the target message comprises at least one of the following:
first information, used to assist the terminal in determining a signal-to-interference-plus-noise ratio (SINR) of the second channel information based on a SINR of the first channel information;
second information, used to assist the terminal in determining a random matrix, the random matrix being used by the terminal to determine the target CQI based on the first channel information;
third information, used to assist the terminal in determining the target CQI based on a CQI corresponding to the first channel information;
a target model;
fourth information, used to instruct the terminal to determine the CQI corresponding to the first channel information as the target CQI; or
fifth information, used to instruct the terminal to determine the target CQI based on a target mapping relationship; and the target mapping relationship comprising a corresponding relationship between SINR and CQI.

3. The CQI transmission method according to claim 2, wherein the first information comprises at least one of the following:
a signal-to-interference-plus-noise ratio (SINR) backoff value;
a power ratio; or
an amplitude ratio.

4. The CQI transmission method according to claim 3, wherein when the first channel information is a multi-rank precoding matrix, the first information corresponds to a layer of the multi-rank precoding matrix, or the first information corresponds to a rank of the multi-rank precoding matrix.

5. The CQI transmission method according to claim 3, wherein the determining, by a terminal, a target CQI corresponding to second channel information based on first channel information and a target message comprises:
when the target message comprises the first information, determining, by the terminal, the SINR of the second channel information based on the SINR of the first channel information and the first information; and
determining, by the terminal, the target CQI based on the SINR of the second channel information.

6. The CQI transmission method according to claim 2, wherein the second information comprises at least one of the following:
a power ratio;
an amplitude ratio;
a random perturbation value; or
a similarity between the first channel information and the second channel information.

7. The CQI transmission method according to claim 2, wherein the determining, by a terminal, a target CQI corresponding to second channel information based on first channel information and a target message comprises:
when the target message comprises the second information, determining, by the terminal, the random matrix based on the second information;
determining, by the terminal, third channel information based on the random matrix and the first channel information; and
determining, by the terminal, the target CQI based on a SINR of the third channel information.

8. The CQI transmission method according to claim 2, wherein the determining, by a terminal, a target CQI corresponding to second channel information based on first channel information and a target message comprises at least one of the following:
when the target message comprises the third information, determining, by the terminal, the target CQI based on the CQI corresponding to the first channel information and the third information;
when the target message comprises the target model, determining, by the terminal, a CQI corresponding to channel information obtained by decoding the channel characteristic information using the target model as the target CQI; or
when the target message comprises the fifth information, determining, by the terminal, the target CQI based on the target mapping relationship and the SINR of the first channel information.

9. The CQI transmission method according to claim 2, wherein the third information comprises a CQI backoff value or a CQI compensation value.

10. The CQI transmission method according to claim 1, wherein the target message corresponds to a user; or the target message corresponds to the second model.

11. The CQI transmission method according to claim 1, wherein the first channel information comprises: channel information estimated by the terminal; or a precoding matrix obtained by the terminal after computing the estimated channel information.

12. The CQI transmission method according to claim 1, further comprising at least one of the following:
receiving, by the terminal, the target message sent by the first network-side device or a second network-side device;
obtaining, by the terminal, the target message based on a protocol agreement; or
receiving, by the terminal, the target message sent by a communication device via sidelink.

13. The CQI transmission method according to claim 12, wherein the receiving, by the terminal, the target message sent by the first network-side device or a second network-side device comprises:
receiving, by the terminal, a corresponding relationship between the target message sent by the first network-side device or the second network-side device and the second model and an identifier of the second model; and
obtaining, by the terminal, the target message based on the corresponding relationship between the target message and the second model and the identifier of the second model.

14. The CQI transmission method according to claim 12, wherein the second network-side device comprises at least one of the following:
a base station; a core network node; or an artificial intelligence (AI) model training node.

15. The CQI transmission method according to claim 12, wherein the target message is carried in at least one of the following:
downlink control information (DCI);
medium access control (MAC) control element (CE); or
radio resource control (RRC).

16. The CQI transmission method according to claim 12, further comprising at least one of the following:
sending, by the terminal, the first channel information or a CSI identifier to the first network-side device or the second network-side device based on network indication; or
sending, by the terminal, the first channel information or the channel characteristic information to the first network-side device or the second network-side device based on network indication.

17. The CQI transmission method according to claim 16, wherein the first channel information is carried when the terminal reports channel state information CSI to the first network-side device based on network indication.

18. A terminal, comprising: a memory storing a computer program; and a processor coupled to the memory and configured to execute the computer program to perform operations comprising:
determining a target channel quality indicator (CQI) corresponding to second channel information based on first channel information and a target message; and
sending the target CQI to a first network-side device,
wherein the target message is used to assist the terminal in determining the target CQI; and the second channel information is information obtained by the first network-side device after inputting channel characteristic information into a second model, the channel characteristic information being information obtained by the terminal after inputting the first channel information into a first model.

19. The terminal according to claim 18, wherein the target message comprises at least one of the following:
first information, used to assist the terminal in determining a signal-to-interference-plus-noise ratio (SINR) of the second channel information based on a SINR of the first channel information;
second information, used to assist the terminal in determining a random matrix, the random matrix being used by the terminal to determine the target CQI based on the first channel information;
third information, used to assist the terminal in determining the target CQI based on the CQI corresponding to the first channel information;
a target model;
fourth information, used to instruct the terminal to determine the CQI corresponding to the first channel information as the target CQI; or
fifth information, used to instruct the terminal to determine the target CQI based on a target mapping relationship; and the target mapping relationship comprising a corresponding relationship between SINR and CQI.

20. A non-transitory computer-readable storage medium, storing a computer program, wherein the computer program, when executed by a processor, causes the processor to perform operations comprising:
determining, by a terminal, a target channel quality indicator (CQI) corresponding to second channel information based on first channel information and a target message; and
sending, by the terminal, the target CQI to a first network-side device,
wherein the target message is used to assist the terminal in determining the target CQI; and the second channel information is information obtained by the first network-side device after inputting channel characteristic information into a second model, the channel characteristic information being information obtained by the terminal after inputting the first channel information into a first model.
